(19) United States
(12) Patent Application Publication
(10) Pub. No.: US 2026/0250597 A1
(43) Pub. Date: Aug. 27, 2026

(54) INDUSTRIAL GEAR LUBRICANT

(71) Applicant: The Lubrizol Corporation, Wickliffe, OH (US)

(72) Inventors: BLAYNE M. MCKENZIE, Pepper Pike, OH (US); WILLIAM R.S. BARTON, Belper, Derbyshire (GB)

(73) Assignee: The Lubrizol Corporation, Wickliffe, OH (US)

(21) Appl. No.: 19/160,177

(22) PCT Filed: Feb. 28, 2024
(86) PCT No.: PCT/US2024/017602

§ 371 Date: Aug. 27, 2025

Related U.S. Application Data
(60) Provisional application No. 63/448,793, filed on Feb. 28, 2023.

(51) Int. Cl. C10M 169/04; C10M 133/06; C10M 135/04; C10M 137/10; C10M 141/10; C10M 145/24; C10M 149/22; C10M 157/04; C10M 167/00; C10N 30/00; C10N 30/02; C10N 30/04; C10N 30/06; C10N 30/12; C10N 30/18; F16H 57/04

(52) U.S. Cl. CPC C10M 169/048; C10M 133/06; C10M 135/04; C10M 137/10; C10M 141/10; C10M 145/24; C10M 149/22; C10M 157/04; C10M 167/00; F16H 57/04; C10M 2203/003; C10M 2203/1006; C10M 2209/103; C10M 2215/04; C10M 2217/046; C10M 2219/022; C10M 2223/045; C10N 2030/02; C10N 2030/04; C10N 2030/06; C10N 2030/12; C10N 2030/18; C10N 2030/24; C10N 2030/43

(57) ABSTRACT

The present technology includes a combination of a sulfurized olefin extreme pressure agent and zinc dialkyl dithiophosphate to provide an industrial gear lubricating composition that provides good extreme pressure performance for industrial gears with reduced sulfur content. The invention includes a lubricating composition comprising an oil of lubricating viscosity, an extreme pressure agent comprising a sulfurized olefin in an amount to deliver up to 3000 ppm sulfur to the lubricating composition, and a zinc dialkyl dithiophosphate agent in an amount to deliver 100 ppm to 600 ppm phosphorous to the lubricating composition, wherein the lubricating composition has a total sulfur content of less than about 6000 ppm sulfur.

### BACKGROUND OF THE INVENTION

Industrial gearboxes see extreme operating conditions that can lead to damage, for example, wear to the internal components of the gearbox. This damage reduces the life of the industrial gearbox and can lead to costly and prolonged maintenance, repair costs, unscheduled downtime for the equipment that contains the industrial gearbox, and similar problems.

There is an on-going need for improved industrial gearbox lubricants for the protection of industrial gearboxes to aid in extending the service life of the industrial gearboxes and the equipment that contains them.

One means of protecting an industrial gearbox is to lubricate the gearbox with a lubricant having sulfur containing compounds. The sulfur in the sulfur containing compounds can react with the metal surfaces of gears to provide a thin protective layer over the metal surface that is resistant to extreme pressures. However, the use of high amounts of sulfur can result in some environmental concerns.

Because of the importance of sulfur in providing protection against extreme pressures, there has not been a viable solution to the reduction or elimination of such sulfur-containing compounds while maintaining extreme pressure performance. Therefore, there is a need to develop industrial gear lubricating compositions with reduced amounts of sulfur while maintaining adequate protection for the industrial gears.

### SUMMARY OF THE INVENTION

The present invention provides a lubricating composition for industrial gears. The lubricating composition comprises an oil of lubricating viscosity, a sulfurized olefin extreme pressure agent, and a zinc dialkyl dithiophosphate (“ZDDP”).

In one embodiment, the sulfurized olefin extreme pressure agent is present in the lubricating composition in an amount to deliver up to 3000 ppm sulfur to the lubricating composition. In one embodiment, the sulfurized olefin extreme pressure agent comprises or consists of a sulfurized olefin containing 2 to 40 carbon atoms. In another embodiment, the sulfurized olefin extreme pressure agent comprises or consists of sulfurized isobutylene. In another embodiment, the sulfurized olefin may comprise a sulfurized olefin derived from natural sources, such as sulfurized vegetable oil or sulfurized lard.

In one embodiment, the ZDDP is present in the lubricating composition in an amount sufficient to deliver 100 ppm to 600 ppm phosphorous to the lubricating composition. In one embodiment, the ZDDP is derived from C3 to C12 secondary alcohols. In another embodiment, the ZDDP contains at least 30 mol % secondary alkyl groups, or at least 50 mol % secondary alkyl groups, or at least 90 mol % secondary alkyl groups. In another embodiment, the ZDDP contains alkyl groups comprising or consisting essentially of secondary alkyl groups containing 3 to 12 carbon atoms. In another embodiment, the ZDDP contains at least 25 mol %, or at least 40 mol % or even at least 60 mol % alkyl groups having 3 or 4 carbon atoms.

It has been observed that the present invention provides suitable gearbox protection, as measured by Timken (ASTM D2782), by employing the components described herein.

There is also provided a method of operating an industrial gear comprising applying to the industrial gear an industrial gear oil as described herein and operating the industrial gear.

### DETAILED DESCRIPTION OF THE INVENTION

Various preferred features and embodiments will be described below by way of non-limiting illustration.

The present technology relates in part to a lubricating composition comprising (a) an oil of lubricating viscosity, (b) a sulfurized olefin, and (c) a zinc dialkyl dithiophosphate.

### Oil of Lubricating Viscosity

In the present invention, the oil of lubricating viscosity can be present in a major amount, for a lubricant composition, or in a concentrate forming amount, for a concentrate and/or additive composition. The oil of lubricating viscosity may be biodegradable or non-biodegradable. The additives described herein can be admixed with an oil of lubricating viscosity to prepare an industrial gear lubricant that unexpectedly provides equivalent or improved industrial gear lubricant performance at lower sulfur concentrations.

Suitable oils include natural and synthetic lubricating oils and mixtures thereof. In a fully formulated lubricant, the oil of lubricating viscosity is generally present in a major amount (i.e. an amount greater than 50 wt %). Typically, the oil of lubricating viscosity is present in an amount of 75 to 98 wt %, and often greater than 80 wt % of the overall composition.

The oil of lubricating viscosity may include natural and synthetic oils, oil derived from hydrocracking, hydrogenation, and hydrofinishing, unrefined, refined and re-refined oils or mixtures thereof. Unrefined oils are those obtained directly from a natural or synthetic source generally without (or with little) further purification treatment. Refined oils are similar to the unrefined oils except they have been further treated in one or more purification steps to improve one or more properties. Purification techniques are known in the art and include solvent extraction, secondary distillation, acid or base extraction, filtration, percolation and similar processes. Re-refined oils are also known as reclaimed or reprocessed oils and are obtained by processes similar to those used to obtain refined oils. Re-refined oils often are processed by techniques directed to removal of spent additives and oil breakdown products.

Natural oils useful as the oil of lubricating viscosity include animal oils and vegetable oils (e.g., castor oil, lard oil), mineral lubricating oils such as liquid petroleum oils and solvent-treated or acid-treated mineral lubricating oils of the paraffinic, naphthenic or mixed paraffinic naphthenic types and oils derived from coal or shale or mixtures thereof.

The industrial gear lubricant may contain a synthetic oil of lubricating viscosity. Synthetic oils may be saturated or unsaturated. Synthetic oils of lubricating viscosity include hydrocarbon oils such as polymerized and interpolymerised olefins (e.g., polybutylenes, polypropylenes, propyleneisobutylene copolymers); poly(1-hexenes), poly(1-octenes), poly(1-decenes), and mixtures thereof; alkyl-benzenes (e.g., dodecylbenzenes, tetradecylbenzenes, dinonylbenzenes, di-(2-ethylhexyl)-benzenes); polyphenyls (e.g., biphenyls, terphenyls, alkylated polyphenyls); esters and complex esters from vegetable sourced acids (e.g., diesters, mono esters, saturated polyol esters, trimethyl propane carboxylic esters, neopolyol carboxylic esters, neopentyl glycol esters, pentaerithrytol esters and the like); alkylated biphenyl ethers and alkylated biphenyl sulfides and the derivatives, analogs and homologs thereof or mixtures thereof. In some embodiments the oil of lubricating viscosity used in the invention is a synthetic oil that includes polymerized polyisobutylene, and in some embodiments the oil of lubricating viscosity used in the invention is a synthetic oil that includes polymerized polyisobutylene and a polyalphaolefin.

Another synthetic oil of lubricating viscosity includes polyol esters, dicarboxylic esters, liquid esters of phosphorus-containing acids (e.g., tricresyl phosphate, trioctyl phosphate, and the diethyl ester of decane phosphonic acid), or polymeric tetrahydrofurans. Synthetic conventional oil of lubricating viscosity also includes those produced by Fischer-Tropsch reactions and typically may be hydroisomerised Fischer-Tropsch hydrocarbons or waxes. In one embodiment, the oil of lubricating viscosity may be prepared by a Fischer-Tropsch gas-to-liquid synthetic procedure as well as other gas-to-liquid oils.

Oils of lubricating viscosity may further be defined as specified in the American Petroleum Institute (API) Base Oil Interchangeability Guidelines. The five base oil groups are as follows: Group I (sulfur content >0.03 wt %, and/or <90 wt % saturates, viscosity index 80-120); Group II (sulfur content ≤0.03 wt % and ≥90 wt % saturates, viscosity index 80-120); Group III (sulfur content ≤0.03 wt % and ≥90 wt % saturates, viscosity index ≥120); Group IV (all polyalphaolefins, or PAO, such as PAO-2, PAO-4, PAO-5, PAO-6, PAO-7 or PAO-8); and Group V (which encompasses “all others”). The oil of lubricating viscosity may also be an API Group II+ base oil, which term refers to a Group II base oil having a viscosity index greater than or equal to 110 and less than 120, as described in SAE publication “Design Practice: Passenger Car Automatic Transmissions”, fourth Edition, AE-29, 2012, page 12-9, as well as in U.S. Pat. No. 8,216,448, column 1 line 57.

The oil of lubricating viscosity includes API Group I, Group II, Group II+, Group III, Group IV, Group V oil or mixtures thereof. In one embodiment, the oil of lubricating viscosity is an API Group I, Group II, Group III, Group IV oil or mixtures thereof. Preferably, the oil of lubricating viscosity may comprise at least 50% by weight, or at least 75% by weight, or at least 90% by weight, or at least 99% by weight of a Group I base oil. In some embodiments, the lubricating oil employed in the compositions of the invention is essentially only Group I base oil, where small amounts of other types of base oils may be present but not in amounts that significantly impact the properties or performance of the overall composition.

In some embodiments of the invention, the oil of lubricating viscosity includes Group II oil. In some embodiments, the lubricating oil employed in the compositions of the invention is essentially only Group II base oil, where small amounts of other types of base oils may be present but not in amounts that significantly impact the properties or performance of the overall composition.

In some embodiments, the oil of lubricating viscosity may comprise at least 50% by weight, or at least 75% by weight, or at least 90% by weight, or at least 99% by weight of a Group I base oil with the balance being a Group II base oil.

Viscosity grades generally suitable for industrial gear lubricating compositions are usually ISO 68 to 1000. The viscosity of each grade is the kinematic viscosity at 40° C.+/−10% as measured by ASTM D445 or ISO 3104. As such, an ISO 46 is 46 cSt at 40° C. may have a kinematic viscosity of 41.4-50.6 cSt at 40° C. The ISO viscosity classification system is defined in ISO 3448. Exemplary viscosity grades are listed in the table below:

| ISO Viscosity | Kinematic Viscosity at 40° C. |
|---|---|
| Grade (ISO 3448) | (minimum-maximum cSt) |
| VG 2 | 2.0-2.4 |
| VG 3 | 2.9-3.5 |
| VG 5 | 4.1-5.1 |
| VG 7 | 6.1-7.5 |
| VG 10 | 9.0-11.0 |
| VG 15 | 13.5-16.5 |
| VG 22 | 19.8-24.2 |
| VG 32 | 29.8-35.2 |
| VG 46 | 41.1-50.6 |
| VG 68 | 61.2-74.8 |
| VG 100 | 90.0-110 |
| VG 150 | 135-165 |
| VG 220 | 198-242 |
| VG 320 | 288-352 |
| VG 460 | 414-506 |
| VG 680 | 612-748 |
| VG 1000 | 900-1,100 |
| VG 1500 | 1,350-1,650 |
| VG 2200 | 1,980-2,420 |
| VG 3200 | 2,880-3,520 |

Accordingly, in some embodiments, the lubricating composition of the present invention may have an ISO viscosity grade (VG) of 68 to 1000, or 100 to 480, or 150 to 320 or 100, 150, 220, 320, 460, 480, or 1000.

The various described oils of lubricating viscosity may be used alone or in combinations. The oil of lubricating viscosity may be used in the described industrial gear lubricants in the range of about 80 wt % to about 98 wt %, or from 80, 85, 90, 95, 97 or even 97.5 or 98 wt % oil or up to 90, 95, 97, 97.5, or even 98 wt % oil.

### Sulfurized Olefins

Sulfurized olefins are well known commercial materials prepared by reacting a single reactant or a mixture of appropriate reactants with a source of sulfur. The sulfurization reaction generally is conducted at an elevated temperature, e.g., 50-350° C. or 100-200° C., with efficient agitation and often in an inert atmosphere such as nitrogen, optionally in the presence of an inert solvent. The sulfurizing agents can include elemental sulfur, which is preferred, hydrogen sulfide, sulfur halide, sodium sulfide and a mixture of hydrogen sulfide and sulfur or sulfur dioxide. Usually, the amount of sulfur or sulfurizing agent employed is calculated based on the total olefinic unsaturation of the mixture. Typically, 0.5 to 3 moles of sulfur are employed per mole of olefinic bonds. One type of sulfurized olefin can be prepared in accordance with the detailed teachings of U.S. Pat. No. 4,957,651.

In the case of sulfurized olefins, the reactant can be an olefinic compound. Olefinic compounds which may be sulfurized are diverse in nature, and broadly speaking are those that contain at least one olefinic double bond, which is defined as a non-aromatic double bond; that is, a double bond connecting two aliphatic carbon atoms. In its broadest sense, the olefin may be defined by the formula R¹R²C═CR³R⁴ wherein each of R¹, R², R³ and R⁴ can be hydrogen or an organic group. In general, the R groups in the above formula which are not hydrogen may be satisfied by such groups as —C(R⁵)₃, —COOR⁵, —COOM, —X, —YR⁵ or —Ar, wherein each R⁵ is independently hydrogen, alkyl, alkenyl, aryl, substituted alkyl, substituted alkenyl or substituted aryl, with the proviso that any two R⁵ groups can be alkylene or substituted alkylene whereby a ring of up to 12 carbon atoms is formed; M is one equivalent of a metal cation (preferably Group I or II, e.g., sodium, potassium, barium, calcium); X is halogen (e.g., chloro, bromo, or iodo); Y is oxygen or divalent sulfur; Ar is an aryl or substituted aryl group of up to 12 carbon atoms. Any two of R¹, R², R³ and R⁴ may also together form an alkylene or substituted alkylene group; i.e., the olefinic compound may be alicyclic.

The olefinic compound is usually one in which each R group, above, which is not hydrogen is independently alkyl, alkenyl or aryl group. Monoolefinic and diolefinic compounds, particularly the former, are preferred, and especially terminal monoolefinic hydrocarbons; that is, those compounds in which R³ and R⁴ are hydrogen and R¹ and R² are alkyl or aryl, especially alkyl (that is, the olefin is aliphatic) having 1 to 30, or 1 to 16, or 1 to 8, or 1 to 4 carbon atoms. Olefinic compounds having 3 to 30 or 3 to 16 (often fewer than 9) carbon atoms can be used.

Isobutylene, di-isobutylene, butylene, propylene and their dimers, trimers and tetramers, and mixtures thereof are useful as olefinic compounds for sulfurization, as are terpene compounds, that is, various isomeric terpene hydrocarbons having the empirical formula C₁₀H₁₆, as well as various synthetic and naturally occurring oxygen-containing derivatives thereof.

Other sulfurized olefins include those derived from natural sources, such as sulfurized vegetable oils and sulfurized lard oil (that is, sulfurized oils of animal sources generally). Example of natural oils from which such sulfurized olefins may be derived can include, but not be limited to, coconut oil, corn oil, cottonseed oil, castor oil, sunflower oil, olive oil, palm oil, peanut oil, rapeseed oil, safflower oil, sesame oil, soybean oil, tallow, lard, fatty acids, and mixtures thereof. Preferred organic portions for the sulfurized vegetable oil are those derived from sunflower oil, olive oil, and rapeseed oil.

In one embodiment, the sulfur component of the additive package of the present technology may comprise a biodegradable sulfurized olefin derived from a natural source such as sulfurized vegetable oil or sulfurized lard.

The total level of sulfur in the sulfurized olefin can be measured according to ASTM D129Q. Whether biodegradable or non-biodegradable, the sulfurized olefins can have a “high,” “nominal,” or “minimal,” level of total sulfur. A “high” level of sulfur means the sulfurized olefin contains about 30 wt % or greater sulfur. A “nominal” level of sulfur means the sulfurized olefin contains from about 10 to about 30 wt % sulfur, and a “minimal” level of sulfur means the sulfurized olefin contains less than about 10 wt % sulfur, or from about 0.01 to about 10 wt % sulfur.

In the present invention, it has been found that the amount of sulfurized olefin in the lubricating composition can be reduced with the addition of a small amount of ZDDP, which is a known anti-wear agent, while maintaining extreme pressure performance.

In the present invention, the sulfurized olefin can be included in the fully formulated lubricant at a level of about 0.1% by weight to about 0.9% by weight, or from about 0.2% by weight to about 0.8% by weight, or even from about 0.4% by weight to about 0.6% by weight. In some embodiments, the sulfurized olefin can be employed in an amount sufficient to deliver a total active sulfur level in the fully formulated lubricant of 75 ppm to 450 ppm, or 100 ppm to 400 ppm, or even 150 ppm to 300 ppm as measured at 150° C. under ASTM D1662. By “active” it is meant the amount of sulfur available for a reaction at a certain temperature. The mole percent of active sulfurs in a sulfur containing compound is determined empirically according to ASTM D1662. In some embodiments, the sulfurized olefin is present in an amount sufficient to deliver 40% by weight to 60% by weight of the total sulfur in the lubricating composition.

### Zinc Dialkyl Dithiophosphate (ZDDP)

The lubricating composition of the present invention also includes zinc dialkyl dithiophosphate (ZDDP). ZDDP is known in the art and are usually employed as anti-wear agents.

Zinc dialkyldithiophosphates (ZDDP) or simply zinc dithiophosphates (ZDP) are well known and readily available to those skilled in the art of lubricant formulation. Further zinc dialkyldithiophosphates may be described as primary zinc dialkyldithiophosphates or as secondary zinc dialkyldithiophosphates, depending on the structure of the alcohol used in its preparation. In some embodiments the instant compositions may include primary zinc dialkyldithiophosphates. In some embodiments, the compositions include secondary zinc dialkyldithiophosphates. In some embodiments, the compositions include a mixture of primary and secondary zinc dialkyldithiophosphates. In some embodiments, the ZDDP is a mixture of primary and secondary zinc dialkyldithiophosphates where the ratio of primary zinc dialkyldithiophosphates to secondary zinc dialkyldithiophosphates (one a weight basis) is at least 1:1, or even at least 1:1.2, or even at least 1:1.5 or 1:2, or 1:10.

Examples of suitable metal dialkyldithiophosphate include metal salts of the formula:

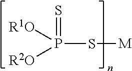

where R¹ and R² are independently hydrocarbyl groups containing 3 to 24 carbon atoms, or 3 to 12 carbon atoms, or 3 to 8 carbon atoms; M is a metal having a valence n and generally incudes zinc, copper, iron, cobalt, antimony, manganese, and combinations thereof. In one embodiment R¹ and R² are secondary aliphatic hydrocarbyl groups containing 3 to 8 carbon atoms, and M is zinc.

In one embodiment, the ZDDP comprises at least 30 mol percent secondary alkyl groups, or at least 50 mol percent secondary alkyl groups, or at least 90 mol percent secondary alkyl groups. In one embodiment, the ZDDP consists essentially of secondary alkyl groups containing 3 to 12 carbon atoms.

In one embodiment, the ZDDP comprises at least 25 mol percent of an alkyl group having 3 or 4 carbon atoms, or at least 40 mol percent of an alkyl group having 3 or 4 carbon atoms, or at least 50 mol percent of an alkyl group having 3 or 4 carbon atoms. In one embodiment, the ZDDP comprises at least 40 mol percent of a secondary alkyl group containing 3 or 4 carbon atoms. Examples of suitable alkyl groups include, isopropyl, sec-butyl, n-butyl, amyl, n-pentyl, methylamyl, n-hexyl, n-octyl, n-nonyl, iso-octyl, 2-ethylhexyl, n-decyl, iso-decyl, n-dodecyl, iso-dodecyl, and any combinations thereof.

ZDDP may be prepared with an amount of zinc in excess of the stoichiometric amount represented in the structure above. A ZDDP prepared in this way can be said to be “overbased”. Overbased ZDDP compositions may be in the form of inert organic liquid solutions characterized by a zinc content in excess of that which would be present according to the stoichiometry of the metal (e.g., zinc) and the particular acidic organic compound (e.g., a low molecular weight dialkyldithiophosphoric acid) reacted with the metal. An overbased (or high basic content) ZDDP will contain more than the stoichiometric amount of the zinc. For example, a low molecular weight dialkyldithiophosphoric acid and/or zinc salt thereof may be reacted with a zinc base and the resulting overbased low molecular weight ZDDP may contain an amount of zinc in excess of that necessary to neutralize the acid, for example, about 1.15 times as much zinc as present in the neutral salt. Stoichioemtric ZDDP has a weight ratio of zinc to phosphorus of 1.05 to 1. Overbased ZDDP may be characterized as having a weight ratio of zinc to phosphorus of at least 1.25 to 1.0, at least 1.28 to 1.0, at least 1.30 to 1.0, or at least 1.32 to 1.0. Accordingly, in some embodiments, the ZDDP may be an overbased (or high basic content) ZDDP wherein the ratio of zinc to phosphorus may range from 1.1:1.0 to 1.3:1.0. In yet other embodiments, the ratio of zinc to phosphorus may be at least 1.25:1.0. In one embodiment, the ZDDP of the invention comprises less than 50 weight percent, or less than 25 weight percent, or less than 5 weight percent of an overbased ZDDP. In one embodiment, the lubricating composition of the invention is free of, or substantially free of overbased (or high basic content) ZDDP.

ZDDP may be present in the lubricating composition of the present inventions in amount of at least 0.1 wt % to 0.5 wt %, or 0.2 wt % to 0.4 wt %, or 0.2 wt % or 0.4 wt % of the lubricating composition. In another embodiment, ZDDP is present in amounts such that the total phosphorous contributed to the lubricant composition is at least 100 ppm to 600 ppm, or 150 ppm to 500 ppm, or 175 ppm to 450 ppm. It should be understood that the zinc dialkyl dithiophosphate also delivers some sulfur to the lubricating composition. Therefore, the zinc dialkyl dithiophosphate may also be considered to be present in amounts to deliver about 200 ppm to about 1000 ppm or about 300 ppm to about 900 ppm sulfur to the lubricating composition.

Without being limited to any particular theory, the impact of adding ZDDP in the present invention is unexpected, at least because, ZDDP is generally understood to function as an antiwear agent, not an extreme pressure agent. In addition, while ZDDP does provide some sulfur to the lubricating composition, ZDDP is generally understood to not provide active sulfur to the lubricating composition. As a result, the additional elemental sulfur added by the inclusion of ZDDP in the lubricating composition would not be expected to have an impact on extreme pressure performance similar to an additive that delivers active sulfur to the lubricating composition.

### Other Additives

The industrial gear lubricant can contain further additive components suitable for industrial gear lubricants. Any combination of conventional additive components suitable for use in industrial gear applications may be used.

The further additive components which may be present in the industrial gear additive package in addition to the sulfurized olefins and ZDDP described above include, but are not limited to, foam inhibitors, demulsifiers, pour point depressants, antioxidants, dispersants, metal deactivators (such as copper deactivators), phosphorus containing antiwear agents, viscosity modifiers, detergents, or some mixture thereof. The other additive components may each be present in the range from 50, 75, 100 or even 150 ppm up to 5, 4, 3, 2 or even 1.5 wt %, or from 75 ppm to 0.5 wt %, from 100 ppm to 0.4 wt %, or from 150 ppm to 0.3 wt %, where the wt % values are with regards to an individual component in respect of a fully formulated industrial gear lubricant. However, it is noted that some additives, including viscosity modifying polymers, which may alternatively be considered as part of the oil of lubricating viscosity, may be present in higher amounts including up to 30, 40, or even 50% by weight when considered separate from the oil of lubricating viscosity. The additives may be used alone or as mixtures thereof.

Phosphorus containing antiwear and/or extreme pressure agents that are typically used in industrial gear lubricants are for the most part partially or fully esterified acids of phosphorus. All of these are suitable for the industrial gear lubricant additive packages herein. Such antiwear agents include, but are not limited to, acid phosphates, hydrogen phosphites, phosphites, phosphates, phosphonates, phosphinates, and phosphoroamidates. Further antiwear agents can also include mono, di and trihydrocarbyl phosphites; mono, di, and trihydrocarbyl phosphates; mono, di, and trihydrocarbyl mono, di, tri, tetrathiophosphates; mono, di, trihydrocarbyl mono, di, tri, tetrathiophosphites; various hydrocarbyl phosphonates and thiophosphonates; dialkyl dithiophosphate esters and derivatives thereof, and various hydrocarbyl phosphonites and thiophosphonites, and the like.

Examples of phosphites include mono-hydrocarbyl substituted phosphite, a di-hydrocarbyl substituted phosphite, or a tri-hydrocarbyl substituted phosphite, and those phosphites having at least one hydrocarbyl group with 4 or more carbon atoms as represented by the formulae:

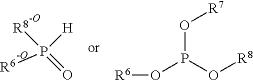

wherein at least one of R⁸, R⁶ and R⁷ may be a hydrocarbyl group containing at least 4 carbon atoms and the other may be hydrogen or a hydrocarbyl group. In one embodiment R⁸, R⁶ and R⁷ are all hydrocarbyl groups. The hydrocarbyl groups may be alkyl, cycloalkyl, aryl, acyclic or mixtures thereof. In the formula with all three groups R⁸, R⁶ and R⁷, the compound may be a tri-hydrocarbyl substituted phosphite i.e., R⁸, R⁶ and R⁷ are all hydrocarbyl groups. Alkyl groups may be linear or branched, typically linear, and saturated or unsaturated, typically saturated. Examples of alkyl groups for R⁸, R⁶ and R⁷ include octyl, 2-ethylhexyl, nonyl, decyl, undecyl, dodecyl, tridecyl, tetradecyl, pentadecyl, hexadecyl, heptadecyl, octadecyl, octadecenyl, nonadecyl, eicosyl or mixtures thereof.

All of the amine salts that can be formed with the above-mentioned phosphorus containing antiwear agents are included. The amines can be primary, secondary, tertiary, acyclic or cyclic, mono or polyamines. They can also be heterocyclic. The preferred amines are generally aliphatic in nature. Some specific examples of amines for producing amine salts of the phosphorus containing antiwear agents include: octylamine, decylamine, C10, C12, C14 and C16 tertiary alkyl primary amines (or combinations thereof), laurylamine, hexadecylamine, heptadecylamine, octadecylamine, decenylamine, dodecenylamine, palmitoylamine, oleylamine, linoleylamine, di-isoamylamine, di-octylamine, di-(2-ethylhexyl)amine, dilaurylamine, cyclohexylamine, 1,2-propylene amine, 1,3-propylenediamine, diethylene triamine, triethylene tetraamine, ethanolamine, triethanolamine, trioctylamine, pyridine, morpholine, 2-methylpiperazine, 1,2-bis(N-piperazinyl-ethane), 1,2-diamine, tetraminooctadecene, triaminooctadecene, N-hexylaniline and the like. The amines may also be triazole or triazole derivatives.

In an embodiment, an amine salt of the phosphorus containing antiwear agent are those of the formula:

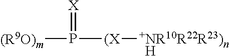

where R⁹ and R¹⁰ are independently aliphatic groups containing from about 4 up to about 24 carbon atoms, R²² and R²³ are independently hydrogen or aliphatic groups containing from about 1 up to about 18 aliphatic carbon atoms, the sum of m and n is 3 and X is oxygen or sulfur. In a preferred embodiment, R⁹ contains from about 8 up to 18 carbon atoms, R¹⁰ is:

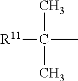

wherein R¹¹ is an aliphatic group containing from about 6 up to about 12 carbon atoms, R²² and R²³ are hydrogen, m is 2, n is 1 and X is oxygen.

Specific examples of phosphorus containing antiwear agents can include tricresyl phosphate, tributylphosphite, triphenyl phosphite, 2-ethylhexyl phosphate, diisobutylhydrogen phosphite, diisopropyl dithiophosphate, diphenyl phosphate, fatty phosphites, etc. Some embodiments of phosphorus containing antiwear agents can include the dialkyl and diaryl phosphates and their amine salts. Also considered are aryl phosphates, such as the commercially available Irgalube™ 349 from Ciba and alkyl acid phosphates, including di- and/or mono-2-ethylhexyl phosphoric acid.

Phosphorous containing anti-wear agents (other than the ZDDP used in the present invention) may be employed in amounts sufficient to deliver 50 ppm to 400 ppm, or 100 ppm to 300 ppm, or even 150 ppm to 250 ppm phosphorous to the lubricant composition.

Antifoams, also known as foam inhibitors, are known in the art and include but are not limited to organic silicones and non-silicon foam inhibitors. Examples of organic silicones include dimethyl silicone and polysiloxanes. Examples of non-silicon foam inhibitors include but are not limited to polyethers, polyacrylates and mixtures thereof as well as copolymers of ethyl acrylate, 2-ethylhexylacrylate, and optionally vinyl acetate. In some embodiments, the antifoam is a polyacrylate. Antifoams may be present in the composition from 0.001 to 0.012 or 0.004 wt % or even 0.001 to 0.003 wt %.

Demulsifiers are known in the art and include but are not limited to derivatives of propylene oxide, ethylene oxide, polyoxyalkylene alcohols, alkyl amines, amino alcohols, diamines or polyamines reacted sequentially with ethylene oxide or substituted ethylene oxides or mixtures thereof. Examples of demulsifiers include polyethylene glycols, polyethylene oxides, polypropylene oxides, (ethylene oxide-propylene oxide) polymers and mixtures thereof. In some embodiments, the demulsifiers are polyethers. Demulsifiers may be present in the composition from 0.002 to 0.2 wt %.

Pour point depressants are known in the art and include but are not limited to esters of maleic anhydride-styrene copolymers, polymethacrylates; polyacrylates; polyacrylamides; condensation products of haloparaffin waxes and aromatic compounds; vinyl carboxylate polymers; and terpolymers of dialkyl fumarates, vinyl esters of fatty acids, ethylene-vinyl acetate copolymers, alkyl phenol formaldehyde condensation resins, alkyl vinyl ethers and mixtures thereof.

The compositions of the present technology may also include a rust inhibitor. Suitable rust inhibitors include hydrocarbyl amine salts of dialkyldithiophosphoric acid, hydrocarbyl amine salts of hydrocarbyl arenesulphonic acid and fatty carboxylic acids or esters thereof, an ester of a nitrogen-containing carboxylic acid, an ammonium sulfonate, an imidazoline, mono-thio phosphate salts or esters, or any combination thereof, or mixtures thereof.

Examples of hydrocarbyl amine salts of dialkyldithiophosphoric acid of the technology include but are not limited to the reaction product(s) of diheptyl or dioctyl or dinonyl dithiophosphoric acids with ethylenediamine, morpholine or Primene™ 81R or mixtures thereof.

Suitable hydrocarbyl amine salts of hydrocarbyl arenesulphonic acids used in the rust inhibitor package of the technology are represented by the formula:

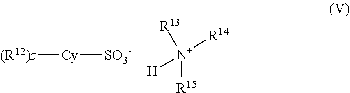

wherein Cy is a benzene or naphthalene ring. R¹² is a hydrocarbyl group with about 4 to about 30, preferably about 6 to about 25, more preferably about 8 to about 20 carbon atoms. z is independently 1, 2, 3, or 4 and most preferably z is 1 or 2. R¹³, R¹⁴ and R¹⁵ are independently hydrogen, alkyl branched or linear alkyl chains, and in some embodiments at least one, or even two of R¹³, R¹⁴ and R¹⁵ are hydrogen, and further where at least one of R¹³, R¹⁴ and R¹⁵ is a hydrocarbyl group containing at least 8 carbon atoms. Examples of alkyl groups suitable for R¹³, R¹⁴ and R¹⁵ include but are not limited to butyl, see butyl, isobutyl, tert-butyl, pentyl, n-hexyl, sec-hexyl, n-octyl, 2-ethyl, hexyl, ethyl-hexyl, decyl, undecyl, dodecyl, tridecyl, tetradecyl, pentadecyl, hexadecyl, heptadecyl, octadecyl, octadecenyl, nonadecyl, eicosyl or mixtures thereof. Examples of hydrocarbyl amine salts of hydrocarbyl arenesulphonic acid of the technology include but are not limited to the ethylenediamine salt of dinonylnaphthalene sulfonic acid. Examples of suitable fatty carboxylic acids or esters thereof include glycerol monooleate and oleic acid.

An example of a suitable ester of a nitrogen-containing carboxylic acid includes oleyl sarcosine. The rust inhibitors may be present in the range from 0.02 to 0.2, from 0.03 to 0.15, from 0.04 to 0.12, or from 0.05 to 0.1 wt % of the industrial gear lubricant. The rust inhibitors of the present technology may be used alone or in mixtures thereof.

The compositions of the present technology may also include a metal deactivator. Metal deactivators are used to neutralise the catalytic effect of metal for promoting oxidation in the industrial gear lubricant. Suitable metal deactivators include but are not limited to triazoles, tolyltriazoles, a thiadiazole, or combinations thereof, as well as derivatives thereof. Examples include derivatives of benzotriazoles, benzimidazole, 2-alkyldithiobenzimidazoles, 2-alkyldithiobenzothiazoles, 2-(N,N′-dialkyldithio-carbamoyl)benzothiazoles, 2,5-bis(alkyl-dithio)-1,3,4-thiadiazoles, 2,5-bis(N,N′-dialkyldithiocarbamoyl)-1,3,4-thiadiazoles, 2-alkyldithio-5-mercapto thiadiazoles or mixtures thereof. These additives may be used from 0.01 to 0.25 wt % in the overall composition. In some embodiments the metal deactivator is a hydrocarbyl substituted benzotriazole compound. The benzotriazole compounds with hydrocarbyl substitutions include at least one of the following ring positions 1- or 2- or 4- or 5- or 6- or 7-benzotriazoles. The hydrocarbyl groups contain about 1 to about 30, preferably about 1 to about 15, more preferably about 1 to about 7 carbon atoms, and most preferably the metal deactivator is 5-methylbenzotriazole used alone or mixtures thereof. The metal deactivators may be present in the range from 0.001 to 0.5, from 0.01 to 0.04 or from 0.015 to 0.03 wt % of the industrial gear lubricant. Metal deactivators may also be present in the composition from 0.002 or 0.004 to 0.02 wt %. The metal deactivator may be used alone or mixtures thereof.

Antioxidants may also be present including (i) an alkylated diphenylamine, and (ii) a substituted hydrocarbyl mono-sulfide. In some embodiments the alkylated diphenylamines of the technology are bis-nonylated diphenylamine and bis-octylated diphenylamine. In some embodiments the substituted hydrocarbyl monosulfides include n-dodecyl-2-hydroxyethyl sulfide, 1-(tert-dodecylthio)-2-propanol, or combinations thereof. In some embodiments the substituted hydrocarbyl monosulfide is 1-(tert-dodecylthio)-2-propanol. The antioxidant package may also include sterically hindered phenols. Examples of suitable hydrocarbyl groups for the sterically hindered phenols include but are not limited to 2-ethylhexyl or n-butyl ester, dodecyl or mixtures thereof. Examples of methylene-bridged sterically hindered phenols include but are not limited to 4,4′-methylene-bis(6-tert-butyl o-cresol), 4,4′-methylene-bis(2-tert-amyl-o-cresol), 2,2′-methylene-bis(4-methyl-6-tert-butylphenol), 4,4′-methylene-bis(2,6-di-tertbutylphenol) or mixtures thereof. The antioxidants may be present in the composition from 0.01 wt % to 6.0 wt %, or from 0.02 wt % to 1 wt %. The additive may be present in the composition at 1 wt %, 0.5 wt %, or less.

In some embodiments, the industrial gear lubricant additive package of the present technology includes a nitrogen-containing dispersant, for example, a hydrocarbyl substituted nitrogen containing additive. Suitable hydrocarbyl substituted nitrogen containing additives include ashless dispersants and polymeric dispersants. Ashless dispersants are so-named because, as supplied, they do not contain metal and thus do not normally contribute to sulfated ash when added to a lubricant. However, they may, of course, interact with ambient metals once they are added to a lubricant which includes metal-containing species. Likewise, some derivatives of ashless dispersants may be derivatized and contain ash forming molecules, such as, for example, borated derivatives. Ashless dispersants are characterized by a polar group attached to a relatively high molecular weight hydrocarbon chain. Examples of such materials include succinimide dispersants, Mannich dispersants, and borated derivatives thereof.

In one embodiment, the lubricating composition of the present invention may contain a detergent. In some embodiments, the detergent may be a metal-containing detergent. In some embodiments, the metal-containing detergent may be a calcium or magnesium detergent. In one embodiment, the metal-containing detergent may also be an overbased detergent with total base number ranges from 30 to 500 mg KOH/g equivalents. In another embodiment, the metal-containing detergent may be a neutral detergent having a total base number of 0 to 30, or even 0 to 10, or even 30 or lower, or even 10 or lower mg KOH/g equivalents. Detergents may be chosen from non-sulfur containing phenates, sulfur containing phenates, sulfonates, salixarates, salicylates, and mixtures thereof, or borated equivalents thereof. Detergents may be borated with a borating agent such as boric acid such as a borated overbased calcium or magnesium sulfonate detergent, or mixtures thereof. The detergent may be present at 0 wt % to 5 wt %, or 0.001 wt % to 1.5 wt %, or 0.005 wt % to 1 wt %, or 0.01 wt % to 0.5 wt % of the hydraulic composition. In some embodiments, the lubricating composition of the present invention is substantially free of free of metal-containing detergents.

In some embodiments, the industrial gear additive packages, or the resulting industrial gear lubricant compositions, include a demulsifier, a corrosion inhibitor, a friction modifier, or combination of two or more thereof. In some embodiments the corrosion inhibitor includes a tolyltriazole. In still other embodiments, the industrial gear additive packages, or the resulting industrial gear lubricant compositions, include one or more polysulfides; one or more phosphorus amine salts; one or more thiophosphate esters, one or more thiadiazoles, tolyltriazoles, polyethers, and/or alkenyl amines; one or more ester copolymers; one or more carboxylic esters; one or more succinimide dispersants, or any combination thereof.

In an industrial gear lubricating composition of the present invention, the oil of lubricating viscosity, may be present from 80%, 85%, 90%, 95%, 97% or even 97.5% or 98% by weight oil up to 90%, 95%, 97%, 97.5%, or even 98% by weight; the sulfurized olefin in amounts of about 0.1% to about 0.9%, or about 0.2% to about 0.8%, or about 0.4% to about 0.6% by weight, and the zinc dialkyl dithiophosphate in amounts of about 0.05% to about 0.8%, or about 0.1% to about 0.6%, or about 0.15% to about 0.5%, or even about 0.2% to about 0.4% by weight. Preferably, the industrial gear lubricating composition contains a maximum of about 6000 ppm sulfur, no more than about 3000 ppm of which is delivered by the sulfurized olefin.

The industrial gear lubricant of the present technology can meet the performance requirements required of an industrial gear lubricant, as well as standards set for environmental friendliness.

Industrial gear oils (IGOs) must maintain a specified level of performance in the typical bench tests that have been part of well-known industrial gear approvals like USS 224, AGMA 9005-D94, recently replaced by AGMA 9005-E02, DIN 51517-3:2009-06, Fives Cincinnati, etc. With respect to extreme pressure performance, the bench tests include, for example, Four Ball EP (ASTM D2783), Timken (ASTM D2782). Other tests include Four Ball Wear (ASTM D4172), FZG Scuffing (DIN ISO 14635-1), Copper Corrosion Protection (ASTM D130, ISO 2160), Oxidation Control (ASTM D2893, DIN EN ISO 4263-4, S-200), Rust Prevention (ASTM D665, ISO 7120), Static Seal Compatibility (DIN EN ISO 1817), Demulsibility (ASTM D2711, ASTM D1401, ISO 6614), Foam Control (ASTM D892, ISO 6247), etc.

The invention includes methods of making the industrial gear lubricants and/or the industrial gear additive concentrates described above. Such methods include mixing the described components together. No particular order or means of addition is believed to significantly impact the results.

The invention also includes a method adding one of the industrial gear lubricants described herein to an industrial gearbox and then operating that industrial gearbox.

As used herein, the term “condensation product” is intended to encompass esters, amides, imides and other such materials that may be prepared by a condensation reaction of an acid or a reactive equivalent of an acid (e.g., an acid halide, anhydride, or ester) with an alcohol or amine, irrespective of whether a condensation reaction is actually performed to lead directly to the product. Thus, for example, a particular ester may be prepared by a transesterification reaction rather than directly by a condensation reaction. The resulting product is still considered a condensation product.

The amount of each chemical component described is presented exclusive of any solvent or diluent oil, which may be customarily present in the commercial material, that is, on an active chemical basis, unless otherwise indicated. However, unless otherwise indicated, each chemical or composition referred to herein should be interpreted as being a commercial grade material which may contain the isomers, by-products, derivatives, and other such materials which are normally understood to be present in the commercial grade.

As used herein, the term “hydrocarbyl substituent” or “hydrocarbyl group” is used in its ordinary sense, which is well-known to those skilled in the art. Specifically, it refers to a group having a carbon atom directly attached to the remainder of the molecule and having predominantly hydrocarbon character. Examples of hydrocarbyl groups include: hydrocarbon substituents, including aliphatic, alicyclic, and aromatic substituents; substituted hydrocarbon substituents, that is, substituents containing non-hydrocarbon groups which, in the context of this technology, do not alter the predominantly hydrocarbon nature of the substituent; and hetero substituents, that is, substituents which similarly have a predominantly hydrocarbon character but contain other than carbon in a ring or chain. A more detailed definition of the term “hydrocarbyl substituent” or “hydrocarbyl group” is found in paragraphs [0137] to [0141] of published application US 2010-0197536.

It is known that some of the materials described above may interact in the final formulation, so that the components of the final formulation may be different from those that are initially added. For instance, metal ions (of, e.g., a detergent) can migrate to other acidic or anionic sites of other molecules. The products formed thereby, including the products formed upon employing the composition of the present technology in its intended use, may not be susceptible of easy description. Nevertheless, all such modifications and reaction products are included within the scope of the present technology; the present technology encompasses the composition prepared by admixing the components described above.

### Examples

A series of lubricants are prepared as shown in Table 1. Each lubricating composition was tested for extreme pressure performance according to ASTM D2782.

TABLE 1
Lubricant Formulations¹

| | Example | Example | Example | Example | Example | Example | Example |
|---|---|---|---|---|---|---|---|
| | 1 | 2 | 3 | 4 | 5 | 6 | 7 |
| Group I base oil | Balance to 100% | | | | | | |
| Sulfurized olefin | 1.2 | 0.6 | 0.6 | 0.6 | 0.6 | 0.6 | |
| A² | | | | | | | |
| Sulfurized olefin | | | | | | | 0.6 |
| B³ | | | | | | | |
| ZDDP A⁴ | | | 0.18 | | | | |
| ZDDP B⁵ | | | | | 0.18 | 0.36 | 0.36 |
| ZDDP C⁶ | | | | 0.18 | | | |
| Alkyl hydrogen⁷ | 0.152 | 0.152 | 0.152 | 0.152 | 0.152 | 0.152 | 0.152 |
| phosphite | | | | | | | |
| Amine phosphate | 0.045 | 0.045 | 0.045 | 0.045 | 0.045 | 0.045 | 0.045 |
| salt⁸ | | | | | | | |
| polyolefin amide | 0.07 | 0.07 | 0.07 | 0.07 | 0.07 | 0.07 | 0.07 |
| alkeneamine⁹ | | | | | | | |
| Other Additives¹⁰ | 0.13 | 0.13 | 0.13 | 0.13 | 0.13 | 0.13 | 0.13 |
| Sulfur (ppm) | 7150 | 4800 | 5200 | 5120 | 5440 | 5830 | 5870 |
| Phosphorus (ppm) | 220 | 230 | 400 | 350 | 440 | 640 | 625 |
| Sulfur from Sulf. | 4800 | 2400 | 2400 | 2400 | 2400 | 2400 | 2500 |
| olefin (ppm)¹¹ | | | | | | | |
| Timken Load | 70, 70 | 27, 27 | 40, 35 | 35, 35 | 75, 70 | 75, 70 | 70, 75 |
| (ASTM D2782)¹² | | | | | | | |

¹All amounts shown above are in weight percent and are on an oil-free basis unless otherwise noted.
²Sulfurized isobutylene (43 wt % sulfur; 10 wt % active sulfur, by ASTM D1662)
³Sulfurized isobutylene (45 wt % sulfur; 35-40 wt % active sulfur, by ASTM D1662)
⁴Zinc dialkyldithiophosphate with secondary C6 alkyl groups, and a ratio of zinc to phosphorous of about 1.1 to 1
⁵Zinc dialkyldithiophosphate with a mixture of secondary C3 and C6 alkyl groups (60:40 mol ratio, respectively) and a ratio of zinc to phosphorous of about 1.1 to 1
⁶Zinc dialkyldithiophosphate with primary C8 alkyl groups and a ratio of zinc to phosphorous of about 1.3 to 1.
⁷Cyclic phosphonate of 2-butyl-2-ethylpropane-1,3-diol (70 wt % cyclic species; 26 wt % oligomeric species)
⁸2-ethylhexylamine salted octylphosphate mixture
⁹Reaction product of PIBSA (Mn 1000; TAN 108) with polyethylene polyamine mixture
¹⁰Other additives include corrosion inhibitors, metal passivators, emulsifiers, pourpoint depressant, anti-foam agent, and lubricity additives
¹¹Calculated
¹²Load at failure, repeat runs, measured in pounds (lb.) In accordance with ASTM D2782, when the load is under 30 pounds, the test incrementally increases by 3 pounds until failure. Once the test crosses the 30-pound threshold, increments are increased by 5 pounds until failure. The test result preceding the failure amount is recorded in accordance with ASTM D2782.

As seen by Table 1, lubricating compositions of the present invention show an improvement of at least two stages in Timken Load extreme pressure performance even at low treat rates.

Advantages of the lubricating composition of the present invention may also be show by evaluation of the lubricating composition according to various tests including but not limited to 4-ball wear (ASTM D4172), 4-ball EP (ASTM D2783), Oxidation (ASTM D2893 at 121 C), Oxidation (ASTM D2893 at 95 C), Steel corrosion (ASTM D665B), Copper corrosion (ASTM D130, 3 h, 100 C), Demulse (ASTM D2711B), Foam (ASTM D892), FZG scuffing A/8.3/90 (ASTM D5182), FE-8 (DIN 51819-3).

Particular aspects of the present invention are more fully set out in the following clauses.

Clause 1: A lubricating composition comprising: an oil of lubricating viscosity; an extreme pressure agent comprising a sulfurized olefin in an amount to deliver up to 3000 ppm sulfur to the lubricating composition; and a zinc dialkyl dithiophosphate (ZDDP) in an amount to deliver 100 ppm to 600 ppm phosphorous to the lubricating composition, wherein the lubricating composition has a total sulfur content of less than about 6000 ppm sulfur, or even less than 5900 ppm, sulfur.

Clause 2: The lubricating composition of clause 1 wherein the extreme pressure agent comprising a sulfurized olefin is present in an amount to deliver up 1000 ppm to 3000 ppm sulfur to the lubricating composition.

Clause 3: The lubricating composition of clause 1 or 2, wherein the extreme pressure agent comprising a sulfurized olefin is present in an amount to deliver 2000 ppm to 2500 ppm sulfur to the lubricating composition.

Clause 4: The lubricating composition of any preceding clause, wherein the ZDDP is present in an amount to deliver 150 ppm to 500 ppm phosphorous to the lubricating composition.

Clause 5: The lubricating composition of any preceding clause, wherein the ZDDP is present in an amount to deliver 175 ppm to 450 ppm phosphorous to the lubricating composition.

Clause 6: The lubricating composition of any preceding clause, wherein the lubricating composition has a total sulfur content of about 4500 ppm to about 6000 ppm.

Clause 7: The lubricating composition of any preceding clause, wherein the lubricating composition has a total sulfur content of about 5000 ppm to about 5900 ppm.

Clause 8: The lubricating composition of any preceding clause, wherein the ZDDP is derived from a primary alcohol.

Clause 9: The lubricating composition of any preceding clause, wherein the ZDDP is derived from a secondary alcohol.

Clause 10: The lubricating composition of any preceding clause, wherein the ZDDP is derived from a mixture of a primary alcohol and a secondary alcohol.

Clause 11: The lubricating composition of any preceding clause, wherein the ZDDP is derived from C3 to C12 secondary alcohols.

Clause 12: The lubricating composition of any preceding clause, wherein the ZDDP contains at least 30 mol % secondary alkyl groups.

Clause 13: The lubricating composition of any preceding clause, wherein the ZDDP contains at least 50 mol % secondary alkyl groups.

Clause 14: The lubricating composition of any preceding clause, wherein the ZDDP contains at least 90 mol % secondary alkyl groups.

Clause 15: The lubricating composition of any preceding clause, wherein the ZDDP contains alkyl groups comprising secondary alkyl groups containing 3 to 12 carbon atoms.

Clause 16: The lubricating composition of any preceding clause, wherein the ZDDP contains alkyl groups consisting essentially of secondary alkyl groups containing 3 to 12 carbon atoms.

Clause 17. The lubricating composition of any preceding clause, wherein the ZDDP contains at least 25 mol %, or at least 40 mol % alkyl groups having 3 or 4 carbon atoms.

Clause 18: The lubricating composition of any preceding clause, wherein the ZDDP contains at least 40 mol % of secondary alkyl groups having 3 or 4 carbon atoms.

Clause 19: The lubricating composition of any preceding clause wherein the ZDDP comprises or consists of ZDP having a 60:40 mole ration of C3 and C6 secondary alkyl groups.

Clause 20: the lubricating composition of any preceding clause wherein the ZDDP is an overbased (or high basic content) ZDDP and wherein the ratio of zinc to phosphorus may range from 1.1:1.0 to 1.3:1.0.

Clause 21: The lubricating composition of any preceding clause, wherein ZDDP has a ratio of zinc to phosphorus of at least 1.25:1.0.

Clause 22: The lubricating composition of any preceding clause, wherein the ZDDP comprises less than 50 weight percent, or less than 25 weight percent, or less than 5 weight percent of an overbased ZDDP.

Clause 23: The lubricating composition of any preceding clause, wherein the lubricating composition of the invention is free of, or substantially free of overbased (or high basic content) ZDDP.

Clause 24: The lubricating composition of any preceding clause, wherein the sulfurized olefin contains 2 to 40 or 2 to 8 carbon atoms.

Clause 25: The lubricating composition of any preceding clause, wherein the sulfurized olefin comprises sulfurized isobutylene.

Clause 26: The lubricating composition of any preceding clause, wherein the sulfurized olefin consists of sulfurized isobutylene.

Clause 27: The lubricating composition of any preceding clause, wherein the sulfurized olefin comprises a sulfurized olefin derived from natural sources.

Clause 28: The lubricating composition of any preceding clause, wherein the sulfurized olefin comprises sulfurized vegetable oil or sulfurized lard.

Clause 29: The lubricating composition of any preceding clause, wherein the sulfurized olefin comprises a mixture of sulfurized isobutylene and sulfurized vegetable oil and/or sulfurized lard.

Clause 30: The lubricating composition of any preceding clause, wherein the oil of lubricating viscosity comprises a mineral base oil.

Clause 31: The lubricating composition of any of clauses 1 to 29, wherein the oil of lubricating viscosity comprises a synthetic base oil.

Clause 32: The lubricating composition of any of clauses 1 to 29, wherein the oil of lubricating viscosity comprises a Group I base oil.

Clause 33: The lubricating composition of any of clauses 1 to 29, wherein the oil of lubricating viscosity consists of a Group I base oil.

Clause 34: The lubricating composition of clause 33, wherein the oil of lubricating viscosity is at least 50% by weight Group I base oil.

Clause 35: The lubricating composition of clause 33, wherein the oil of lubricating viscosity is at least 75% by weight Group I base oil.

Clause 36: The lubricating composition of clause 33, wherein the oil of lubricating viscosity is at least 90% by weight Group I base oil.

Clause 37: The lubricating composition of clause 33, wherein the oil of lubricating viscosity is at least 99% by weight Group I base oil.

Clause 38: The lubricating composition of any preceding clause, wherein the lubricating composition has an ISO viscosity grade of 68 to 1000.

Clause 39: The lubricating composition of any preceding clause, wherein the lubricating composition has an ISO viscosity grade of 100 to 480.

Clause 40: The lubricating composition of any preceding clause, wherein the lubricating composition has an ISO viscosity grade of 150 to 320.

Clause 41: The lubricating composition of any preceding clause, wherein the lubricating composition contains 0.15% by weight to 0.9% by weight sulfurized olefin.

Clause 42: The lubricating composition of any preceding clause, wherein the lubricating composition contains 0.2% by weight to 0.8% by weight sulfurized olefin.

Clause 43: The lubricating composition of any preceding clause, wherein the lubricating composition contains 0.4% by weight to 0.6% by weight sulfurized olefin.

Clause 44: The lubricating composition of any preceding clause, wherein the lubricating sulfurized olefin is present in an amount sufficient to deliver 40% by weight to 60% by weight of the total sulfur content.

Clause 45: The lubricating composition of any preceding clause, wherein the lubricating composition contains 50, 75, 100 or even 150 ppm up to 5, 4, 3, 2 or even 1.5 wt %, or from 75 ppm to 0.5 wt %, from 100 ppm to 0.4 wt %, or from 150 ppm to 0.3 wt % up to 5% by weight, or up to 3% by weight, or up to 2% by weight, or 0.1 to 5%, of additional additives selected from foam inhibitors, demulsifiers, pour point depressants, antioxidants, dispersants, metal deactivators, detergents, viscosity modifiers, or some mixture thereof

Clause 46: The lubricating composition of any preceding clause, wherein the lubricating composition further comprises 50 to 400 ppm of a dispersant.

Clause 47: The lubricating composition of clause 46, wherein the dispersant comprises or consists of a polyolefin amide alkeneamine.

Clause 48: The lubricating composition of any preceding clause, wherein the lubricating composition is substantially free of a metal-containing detergent.

Clause 49: The lubricating composition of any preceding clause, wherein the lubricating composition is substantially free of detergents selected from non-sulfur containing phenates, sulfur containing phenates, sulfonates, salixarates, salicylates, and mixtures thereof, or borated equivalents thereof.

Clause 50: The lubricating composition of any preceding clause, wherein the lubricating composition further comprises an alkenyl amine friction modifier.

Clause 51: The lubricating composition of any preceding clause, wherein the lubricating composition further comprises a polyether based demulsifier.

Clause 52: The lubricating composition of any preceding clause, wherein the lubricating composition further comprises a corrosion inhibitor selected from substituted thiadiazole, triazole derivative, or combination thereof.

Clause 53: The lubricating composition of any preceding clause, wherein the lubricating composition further comprises ester copolymer anti-foam agent.

Clause 54: A method of lubricating an industrial gear, comprising: supplying to the industrial gear the lubricating composition of any preceding clause.

Clause 55: The use of the lubricating composition of any of clauses 1 to 53 to improve the extreme pressure performance of an industrial gear.

Clause 56: The use of the lubricating composition of any of clauses 1 to 53 to improve the Timken OK load performance of an industrial gear.

Each of the documents referred to above is incorporated herein by reference, including any prior applications, whether or not specifically listed above, from which priority is claimed. The mention of any document is not an admission that such document qualifies as prior art or constitutes the general knowledge of the skilled person in any jurisdiction. Except in the Examples, or where otherwise explicitly indicated, all numerical quantities in this description specifying amounts of materials, reaction conditions, molecular weights, number of carbon atoms, and the like, are to be understood as modified by the word “about.” It is to be understood that the upper and lower amount, range, and ratio limits set forth herein may be independently combined. Similarly, the ranges and amounts for each element of the technology can be used together with ranges or amounts for any of the other elements.

As used herein, “substantially free” means that the amount of the material in question is less than an amount that will affect the relevant performance of the fluid in a measurable way. “Substantially free” may also mean that the material in question is not intentionally added to the composition but does not exclude the presence of such material as contaminants. “Substantially free” may also mean that the material in question may be present in amounts lower than the detection limit of standard test methods now known to those skilled in the art or hereafter developed. In some embodiments, “substantially free” may mean less than 10 ppm by weight or even less than 5 ppm by weight.

As used herein, the transitional term “comprising,” which is synonymous with “including,” “containing,” or “characterized by,” is inclusive or open-ended and does not exclude additional, un-recited elements or method steps. However, in each recitation of “comprising” herein, it is intended that the term also encompass, as alternative embodiments, the phrases “consisting essentially of” and “consisting of,” where “consisting of” excludes any element or step not specified and “consisting essentially of” permits the inclusion of additional un-recited elements or steps that do not materially affect the essential or basic and novel characteristics of the composition or method under consideration.

While certain representative embodiments and details have been shown for the purpose of illustrating the subject technology, it will be apparent to those skilled in this art that various changes and modifications can be made therein without departing from the scope of the subject technology. In this regard, the scope of the technology is to be limited only by the following claims.

What is claimed is:

1. A lubricating composition comprising:
an oil of lubricating viscosity;
an extreme pressure agent comprising a sulfurized olefin in an amount to deliver up to 3000 ppm sulfur to the lubricating composition; and
a zinc dialkyl dithiophosphate agent in an amount to deliver 100 ppm to 600 ppm phosphorous to the lubricating composition,
wherein the lubricating composition has a total sulfur content of less than about 6000 ppm sulfur.

2. The lubricating composition of claim 1, wherein the zinc dialkyl dithiophosphate is derived a primary alcohol, a secondary alcohol, or a mixture thereof.

3. The lubricating composition of claim 1, wherein the zinc dialkyl dithiophosphate comprises at least 30 mol % secondary alkyl groups, or at least 50 mol % secondary alkyl groups, or at least 90 mol % secondary alkyl groups.

4. The lubricating composition of claim 1, wherein the zinc dialkyl dithiophosphate contains alkyl groups comprising or consisting essentially of secondary alkyl groups containing 3 to 12 carbon atoms.

5. The lubricating composition of claim 1, wherein the zinc dialkyl dithiophosphate contains at least 25 mol %, or at least 40 mol % alkyl groups having 3 or 4 carbon atoms.

6. The lubricating composition of claim 1, wherein the zinc dialkyl dithiophosphate contains a 60:40 mol ratio of C3 and C6 secondary alkyl groups.

7. The lubricating composition of claim 4, wherein the zinc dialkyl dithiophosphate contains secondary C6 alkyl groups.

8. The lubricating composition of claim 1, wherein the sulfurized olefin contains 2 to 40 carbon atoms.

9. The lubricating composition of claim 1, wherein the sulfurized olefin comprises or consists of sulfurized isobutylene.

10. The lubricating composition of claim 1, wherein the sulfurized olefin comprises a sulfurized olefin derived from sulfurized vegetable oil or sulfurized lard.

11. The lubricating composition of claim 1, wherein the sulfurized olefin comprises a mixture of sulfurized isobutylene and a sulfurized olefin derived from natural sources.

12. The lubricating composition of claim 1, wherein the oil of lubricating viscosity comprises a mineral base oil.

13. The lubricating composition of claim 1, wherein the oil of lubricating viscosity comprises a synthetic base oil.

14. The lubricating composition of claim 1, wherein the oil of lubricating viscosity comprises or consists of a Group I base oil.

15. The lubricating composition of claim 14, wherein the oil of lubricating viscosity is at least 50% by weight or at least 75% by weight, or at least 90% by weight, or at least 99% by weight Group I base oil.

16. The lubricating composition of claim 1, wherein the lubricating composition has an ISO viscosity grade of 68 to 1000 or 100 to 480.

17. The lubricating composition of claim 1, wherein the lubricating composition contains 0.15% by weight to 0.9% by weight-by-weight sulfurized olefin.

18. The lubricating composition of claim 1, wherein the lubricating sulfurized olefin is present in an amount sufficient to deliver 40% by weight to 60% by weight of the total sulfur content.

19. The lubricating composition of claim 1, wherein the lubricating composition contains 50, 75, 100 or even 150 ppm up to 5, 4, 3, 2 or even 1.5 wt %, or from 75 ppm to 0.5 wt %, from 100 ppm to 0.4 wt %, or from 150 ppm to 0.3 wt % up to 5% by weight, or up to 3% by weight, or up to 2% by weight, or 0.1 to 5%, of additional additives selected from foam inhibitors, demulsifiers, pour point depressants, antioxidants, dispersants, metal deactivators, detergents, viscosity modifiers, or some mixture thereof.

20. The lubricating composition of claim 1, wherein the lubricating composition further comprises 50 to 400 ppm of a dispersant.

21. The lubricating composition of claim 16, wherein the dispersant comprises or consists of a polyolefin amide alkeneamine.

22. The lubricating composition of claim 1, wherein the lubricating composition is substantially free of a metal-containing detergent.

23. The lubricating composition of claim 1, wherein the lubricating composition further comprises an alkenyl amine friction modifier.

24. The lubricating composition of claim 1, wherein the lubricating composition further comprises a polyether based demulsifier.

25. The lubricating composition of claim 1, wherein the lubricating composition further comprises a corrosion inhibitor selected from substituted thiadiazole, triazole derivative, or combination thereof.

26. The lubricating composition of claim 1, wherein the lubricating composition further comprises ester copolymer anti-foam agent.

27. A method of lubricating an industrial gear, comprising: supplying to the industrial gear the lubricating composition of claim 1.

28. (canceled)

29. (canceled)
